(19) United States
(12) Patent Application Publication
(10) Pub. No.: US 2024/0042877 A1
(43) Pub. Date: Feb. 8, 2024

(54) MARINE CHARGING SYSTEM

(71) Applicant: Kamil Podhola, Liberec (CZ)

(72) Inventor: Kamil Podhola, Liberec (CZ)

(21) Appl. No.: 17/882,647

(22) Filed: Aug. 8, 2022

(51) Int. Cl. B60L 53/31; B60L 53/30; B60L 53/66; B60L 53/80; B60L 53/50

(52) U.S. Cl. CPC B60L 53/31; B60L 53/305; B60L 53/66; B60L 53/80; B60L 53/50

(57) ABSTRACT

The invention relates to a marine charging system for an electric vehicle (MCS) comprising a water vessel providing one or more wired/wireless charging stations to charge/discharge the electric vehicle. The system may provide data transmissions and may be provided in cloud/fog/edge computing systems. The water vessel may be powered by various propulsion systems. It may provide power generators, use regenerative power, swap, provide rechargeable power sources/swappable rechargeable power sources and a thermal management system. The charging stations may provide charging interfaces and both may be provided at about defined naval constructions, be adjustable, mobile. The MCS may be provided in an electric vehicle charging system comprising coupled electric vehicles and in an offshore charging system comprising a coupled marine power source to provide power while the vessel be stationary or in a motion. The MCS may be provided in a modular system. Marine charging and swapping methods are proposed.

This application claims the benefit and priority of International Application No. PCT/IB2021/050590, filed on Jan. 26, 2021

and is hereby incorporated by reference in its entirety.

### TECHNICAL FIELD

The invention relates to a marine charging system for a water vessel.

### BACKGROUND ART

There is a wide range of electric vehicles, of water vessels able to transport these vehicles which are gaining popularity and are becoming more available for a wider range of consumers. They may comprise a rechargeable power source. They may have an improved ecological impact and may be one of sustainable forms of transportation. Many people and companies are attracted to them because they want to decrease their personal impact on the environment through transport.

WO 2019/182300 A1 (4DREAM CO LTD [KR]) 26 Sep. 2019 (hereinafter “D1”) discloses an energy supply vessel and an energy supply method using same, the energy supply vessel comprising: a bull; an electricity storage device for storing electricity at the hull; a charging port provided at the hull for an electrical connection with an external electricity supply target using electricity as a power source, so as to charge the electricity supply target with the electricity supplied from the electricity storage device; a communication unit provided at the hull so as to allow communication with the electricity supply target; a propeller for generating a propulsive force such that the hull moves for the electrical connection with the electricity supply target; and a control unit for controlling the electricity storage device, the charging port, the communication unit, and the propeller according to an operation signal of an operation unit or a determined process. According to the invention, electricity can be easily supplied to an electric propulsion ship, an underwater drone, a water drone, an air drone, an electric vehicle, and other various electricity supply targets using electricity as a power source on the water, under the water, or near the water, or a battery can be replaced and, furthermore, a battery in a floater can be charged, or the energy supply vessel can be used as an uninterruptible power supply device for a floater, a waterside hotel, or the like.

The document fails to disclose charging an electric vehicle situated onboard a water vessel, an advantageous combination of charging station types provided onboard, a marine charging system provided in a cloud computing system, a water vessel propulsed by others than electric motor or fossil fuel systems. The document fails to disclose power generators others than solar or wind energy systems, and using regenerative power. The document fails to disclose first and second swappable rechargeable power sources as thought by the present invention. The document fails to disclose wireless charging stations and interfaces used for charging. The document fails to disclose other naval constructions than decks providing charging stations and/or charging interfaces. The document fails to disclose adjustable and mobile charging interfaces. The document fails to disclose a marine power source providing power to a swappable rechargeable power source of the water vessel and to the first and second swappable rechargeable power sources. The document fails to disclose modularity. The document fails to disclose a marine charging method comprising a step of loading an electric vehicle on board. The document fails to disclose a marine swapping method.

US 2020/254887 A1 (ROBERT BRIAN JOSEPH [US] ET AL) 13 Aug. 2020 (hereinafter “D2”) discloses home energy storage systems that include both a stationary unit for supporting dedicated home energy storage solutions and a modular unit capable of supporting alternative energy storage/power source functionality. This disclosure further relates to the interconnected operations between the stationary unit and the modular unit of home energy storage systems and between the modular unit and satellite equipment that may be associated with the modular unit.

The document fails to disclose features as described ad D1 namely a marine swapping method.

Ishigaki et al. US Pub 2019/0070967 (hereinafter “Ishigaki”) discloses a system including energy modules that output power to an energy management bus based on load demands. An energy module includes energy cells enclosed within a module housing that provide power to the energy management bus and a driving system attached to the module housing that transports the energy module. The energy module includes a local controller that controls power output from the energy cells to the energy management bus, engages a self-driving mode in response to receiving a disconnection signal from a central controller, and controls movement of the energy module in the self-driving mode to a predetermined location via the driving system. The central controller receives a current module status from the energy modules and controls a configuration of the energy modules providing power to the energy management bus based on the current module status.

The document fails to disclose features as described ad D1.

WO 2019/180323 A1 (KONGSBERG MARITIME FINLAND OY [FI]) 26 Sep. 2019 (hereinafter “D3”) discloses an autonomous barge for supplementing a first energy storage of a moving vessel, the autonomous barge comprising a second energy storage, moving means, wireless communication means, a controller and energy connection means. The document discloses batteries provided by an offshore energy storage and located below the surface of water when located at the offshore energy storage to keep the temperature low—hence no additional cooling system is needed.

The document fails to disclose features as described ad D1 namely a thermal management system to thermally manage charging/discharging an electric vehicle onboard or offboard a water vessel; fails to disclose charging/discharging a (swappable) rechargeable power source provided by the water vessel onboard; fails to disclose charging/discharging a first swappable rechargeable power source provided by the water vessel to be swapped onboard or offboard for or a second swappable rechargeable power source provided by the electric vehicle.

EP 2 402 205 A1 (NATION E AG [CH]) 4 Jan. 2012 (hereinafter D4) discloses a computer-controlled electric battery charging systems and methods for charging a battery of a roaming electric vehicle, the system comprising an electric vehicle comprising at least one battery, a master charger vehicle comprising a master battery module and a control system in communication with the at least one electric vehicle and the master charger vehicle to enable the master charger vehicles to reach the electric vehicle, wherein the master battery module is adapted to charge the at least one battery.

The document fails to disclose features as described ad D1 namely an onboard charging system and a marine swapping method.

CN 108 482 595 A (UNIV WUHAN TECH) 4 Sep. 2018 (hereinafter “D5”) discloses a combined system and working method of an offshore floating power generation platform and an unmanned boat cluster. The combined system comprises the offshore floating power generation platform for collecting and storing energy, a charging module for charging an unmanned boat, and a shore-based terminal platform for receiving transmission information of the unmanned boat. The offshore floating power generation platform collects and stores the energy through a solar panel, a vertical shaft wind turbine and an ocean current turbine by adopting a complementary power collection mode. The charging module includes a signal transmitting device, a control unit, a lifting device and a charging module connecting device. The unmanned boat is provided with a GPS positioning system, and the offshore floating power generation platform is provided with a guiding track which corresponds to the charging module.

The document fails to disclose features as described ad D1 namely an onboard charging system and a marine swapping method.

WO 2014/184729 A2 (INST ENERGY APPLIC TECHNOLOGIES CO LTD [JP]) 20 Nov. 2014 (hereinafter “D6”) discloses a rapid charging power supply system capable of rapidly charging an electric moving body, such as a vehicle, and in particular the invention discloses a rapid charging power supply system capable of rapidly charging two electric moving bodies of different charging methods at the same time using a single system.

The document fails to disclose features as described ad D1 namely an onboard charging system and a marine swapping method.

KR 2010 0065542 A (SAMSUNG HEAVY IND [KR]) 17 Jun. 2010 (hereinafter “D7”) discloses a charging station for an electric vessel is provided to remove limit on the trip distance of the electric ship and to facilitate navigation. A charging station for an electric vessel comprises a floater, an electricity generating unit, an electricity storage unit, and an electric supply unit. The floater comprises a mooring unit for mooring the electric ship. The electricity generating unit is installed in the floater for generating electricity. The electricity storage unit is installed in the floater for storing electricity generated from the electricity generating unit.

The document fails to disclose features as described ad D1 namely an onboard charging system and a marine swapping method.

DE 10 2010 010119 A1 (KERN JUERGEN [DE]) 8 Sep. 2011 (hereinafter “D8”) discloses a transporter, in particular a truck, an automobile, a railway wagon, a bus, a trailer or the like, for transporting motor vehicles, comprising a loading surface for receiving the motor vehicles, wherein the transporter further comprises a device for electrically charging the motor vehicles.

The document fails to disclose features as described ad D1 namely an onboard water vessel combined charging system and a marine swapping method.

EP 2 927 045 A1 (ATOS IT SOLUTIONS AND SERVICES GMBH [AT]) 7 Oct. 2015 (hereinafter “D9”) discloses a charger for an electric vehicle on a train wagon comprising a first electric interface for connecting to a busbar of the train wagon, a second electric interface for connecting to the vehicle and a power converter for converting power from the first interface into power for the second interface. In this, the charger is adapted to be moved between train wagons.

The document fails to disclose features as described ad D1 namely an onboard water vessel combined charging system and a marine swapping method.

DE 10 2019 007810 A1 (DAIMLER AG [DE]) 9 Jul. 2020 (hereinafter “D10”) discloses a charging station for a rail vehicle for transporting motor vehicles, comprising a charging unit having a charging connection, designed to charge a traction battery of an electrically operable motor vehicle when the charging station is arranged on a transport device of the rail vehicle, and having a control unit for controlling the charging of the traction battery, wherein the charging station is designed to obtain electrical energy for charging the traction battery via the rail vehicle from an overhead line. The invention also relates to a method for simultaneously transporting and loading motor vehicles on a rail vehicle. A further aspect of the invention relates to a rail vehicle having the above-mentioned charging station.

The document fails to disclose features as described ad D1 namely an onboard water vessel charging system and a marine swapping method.

### DISCLOSURE OF INVENTION

The aforementioned deficiencies are therefore solved by the features of claims 1, 14 and 15. In the dependent claims advantageous developments of the marine charging system according to the invention are given.

There is a need to provide DC charging possibilities for smaller electric vehicles such as bikes, scooters, motorcycles which have no integrated inverter, to provide AC, DC charging possibilities for larger vehicles with an integrated inverter and for relatively longer charging times, to provide fast AC, fast DC charging possibilities for rapid charging (e.g. during a short ferry traject) and to provide different wireless charging possibilities for electrically driven vehicles equipped with different systems. It can be particularly advantageous to provide the claimed combination of charging interface types by one water vessel so that different vehicles with different systems can always find a charging possibility.

It is therefore the object of the present invention to propose a marine charging system for an electric vehicle (MCS) comprising a water vessel providing two or more charging stations to charge/discharge the electric vehicle wherein at least one combination of charging station types is provided.

A further object is to propose the MCS with a defined charging station type.

A further object is to propose the MCS with adjustable/mobile charging interfaces.

A further object is to propose the MCS providing data transmissions.

A further object is to propose the MCS provided in a defined computing system.

A further object is to propose the MCS with a defined water vessel's propulsion system.

A further object is to propose the MCS providing a defined power generator.

A further object is to propose the MCS with the water vessel using regenerative power.

A further object is to propose the MCS providing a first swappable rechargeable power source to be swapped for a second swappable rechargeable power source provided by the electric vehicle.

A further object is to propose the MCS with the water vessel providing a rechargeable power source.

A further object is to propose the MCS with the water vessel providing a thermal management system.

A further object is to propose the MCS with the water vessel providing a defined naval construction where the charging station and/or the charging interface can be provided.

A further object is to propose the MCS provided in an electric vehicle charging system comprising the electric vehicle coupled with the charging station.

A further object is to propose the MCS provided in an offshore charging system comprising a defined marine power source.

A further object is to propose the MCS in a modular system with modules which can be modularly scalable and/or exchangeable.

A further object is to propose a marine charging method for electric vehicles to be charged by combinations of charging station types.

A further object is to propose a marine swapping method for electric vehicles.

Other and further objects will be explained hereinafter and will be particularly pointed out in the appended claims.

In a first aspect, the invention discloses a marine charging system for an electric vehicle.

In a second aspect the invention discloses a marine charging method for an electric vehicle.

In a third aspect the invention discloses a marine swapping method for an electric vehicle.

### BRIEF DESCRIPTION OF DRAWINGS

The invention will now be described by way of example. Only essential elements of the invention are schematically shown and not to scale to facilitate immediate understanding, emphasis being placed upon illustrating the principles of the invention.

FIG. 1 is a schematic plan view of an embodiment of a marine charging system provided in an electric vehicle charging system.

FIG. 2 is a schematic plan view of another embodiment of the marine charging system provided in an offshore charging system.

FIG. 3 is a schematic plan view of another embodiment of the marine charging system with mobile charging stations.

FIG. 4 is a schematic plan view of another embodiment of the marine charging system provided in an electric vehicle charging system and in a stationary offshore charging system with an onshore power source, the system providing a mobile wireless charging interface.

FIG. 5 is a schematic plan view of another embodiment of the marine charging system provided in an electric vehicle charging system and in a stationary offshore charging system with an offshore power source, a water vessel comprising a rechargeable power source.

FIG. 6 is a schematic plan view of another embodiment of the marine charging system provided in an electric vehicle charging system and in a dynamic offshore charging system with an offshore power source, the system providing an adjustable wireless charging interface.

FIG. 7 is a schematic plan view of another embodiment of the marine charging system provided in an electric vehicle charging system, in an offshore charging system and in computing systems.

FIG. 8 is a schematic of an embodiment of a marine charging method.

FIG. 9 is a schematic of an embodiment of a marine swapping method.

FIG. 10 is a schematic of a thermal management system provided in an embodiment of the marine charging system provided in an electric vehicle charging system and in a computing system.

FIG. 11 is a schematic side view of a thermal management system provided in another embodiment of the marine charging system provided in an electric vehicle charging system and in a static/dynamic offshore charging system and in a computing system.

FIG. 12 is a schematic side view of a thermal management system of a wireless charging interface provided on a water vessel deck which can be used in the proposed marine charging system.

FIG. 13 is a perspective illustration of a thermal management system of a wireless charging interface provided on a water vessel deck which can be used in the proposed marine charging system.

FIG. 14 is a schematic of a thermal management system of a charging cable which can be used in the proposed marine charging system.

### BEST MODE FOR CARRYING OUT THE INVENTION

The following detailed description shows the best contemplated modes of exemplary embodiments. The description is made for the purpose of illustrating the general principles of the invention, and in such a detail that a skilled person in the art can recognise the advantages of the invention, and can be able to make and use the invention. The detailed description is not intended to limit the principle of the presented invention, but only to show the possibilities of it.

The terms used in the claims and the specifications shall refer to their synonyms as well.

As used in the claims and the specification, the term “water vessel” shall refer to manned and unmanned water vessels, shall refer to overwater and underwater water vessels, shall refer to amphibious vessels, and shall refer to models and toys as well, shall preferably not exclusively refer to any type of the water vessel arranged to be able to transport directly or indirectly (e.g. to tow another transporting vessel) one or more electric vehicles, shall refer to towing vessels and to towed vessels, shall refer to convoys and combinations wherein elements of the invention can be included in a plurality of coupled/couplable vessels (e.g. a towed vessel including rechargeable power sources/swappable rechargeable power sources and a towing vessel transporting the electric vehicles and including charging stations, etc., similarly for propulsion systems, power generators and other elements).

As used in the claims and the specification, the term “charging station” shall also refer to charger, charging unit, charging interface with a charging cable, charging cable with a charger, untethered charger, tethered charger, charging power interface, and the like, shall refer to basic charging devices (e.g. including a power transfer interface and a power cable) and shall refer to complex charging stations (e.g. including input/output sections, power/communication sections, controllers, data storage, user interfaces/controls, sensors, payment terminals, etc.), shall refer to charging devices configured to charge rechargeable batteries and/or capacitors powering the electric vehicles, shall refer to systems using smart power cables, and shall refer to smart chargers, bidirectional chargers, Level 1, 2, 3, 4 chargers, fast AC chargers, fast DC chargers, Tesla chargers, inductive, capacitive, magnetodynamic chargers, combined chargers, etc.

As used in the claims and the specification, the term “electric vehicle” shall preferably not exclusively refer to an onshore rechargeable vehicle at least partially electrically driven, shall refer to manned and unmanned vehicles, and shall refer to any type of the electric vehicle (including fully electric and hybrid electric) including an electric motor and/or coupled/couplable with a vehicle including an electric motor to directly or indirectly propel the vehicle [e.g. to tow the vehicle], shall refer to amphibious vehicles, and shall refer to models and toys as well, shall also refer to the electric vehicles arranged to use charging/discharging power for other reasons (auxiliary, mobile technology [e.g. cooling systems, etc]), shall refer to convoys and combinations including at least one electric vehicle, shall refer to vehicles including or coupled (couplable) with smart chargers, bidirectional chargers, Level 1, 2, 3, 4 chargers, (fast) AC chargers, (fast) DC chargers, Tesla chargers, wireless inductive, capacitive, magnetodynamic chargers, combined chargers, etc.

The “charging stations” and the “electric vehicles” can be compatible so that the electric vehicles be at least partially chargeable and/or dischargeable by the charging stations. The compatible wired systems can use compatible wired power transfer interfaces [e.g. AC sockets/JSAE 1772, Mennekes Socket, Le-Grand Socket, etc./, DC sockets/CHADeMO, GB/T, Tesla Supercharger, etc./, CCS sockets, etc.] and similarly for compatible wireless power transfer interfaces [e.g. inductive/strongly coupled magnetic resonant pads, double D magnetic polarized pads, etc./, capacitive/primary and secondary capacitive plates, etc./, magnetodynamic/transmission and receiving magnetodynamic interfaces, etc./].

The charging systems provided in the proposed marine charging system can be static, dynamic [e.g. dynamic wired, dynamic wireless] and can be combined [e.g. AC/DC, wired/wireless, inductive/capacitive, static/dynamic, etc.] and can use combined charging interfaces, combined circuit topologies, combined charging units, etc.

As used in the claims and the specification, the term “rechargeable power source” as in “a rechargeable power source provided by said water vessel” shall also refer to a swappable rechargeable power source.

As used in the claims and the specification, the term “internal combustion engine” shall refer to any constructional type inclusive of hydrogen fueled engines, hydrocarbon fuels fueled engines, etc., and shall refer to reciprocating, rotary, continuous combustion engines as well.

As used in the claims and the specification, the term “electric motor” shall refer to any constructional type inclusive of AC, DC motors, jet engines and turbines.

As used in the claims and the specification, the term “sail” shall refer to any constructional type and material inclusive of rotor sails.

As used in the claims and the specification, the term “power generator” shall refer to onshore power generators and/or offshore power generators.

As used in the claims and the specification, the term “motor generator” shall preferably not exclusively refer to electric energy generating systems using an electrical generator coupled with an engine (which can be a jet engine, an engine burning a hydrocarbon fuel, a gas generator, a turbine, etc.) and shall also refer to the term “power plant”, and the like, and shall also refer to mobile units, compact units, enclosed units, portable units, skid mounted units and shall also refer to thermal electric types and atomic types and shall also refer to floating and underwater types and shall also refer to power plants, power units comprising exhaust products (e.g. gases, fluids) treatments.

As used in the claims and the specification, the term “rechargeable power source”, “first swappable rechargeable power source” “second swappable rechargeable power source” shall preferably not exclusively refer to power sources including rechargeable batteries [e.g. strings, packs, modules, cells], capacitors [e.g. strings, packs, modules, cells], hybrid sources, energy storage elements [e.g. hydrocarbon fuel storage, mechanical (e.g. compressed air, compressed gas, flywheel, etc.), electromagnetical (e.g. using superconductors, etc.), electrochemical (e.g. flow battery, ultrabattery, etc.), thermal (e.g. phase change material, cryogenic energy storage, liquid nitrogen engine, etc.), chemical (e.g. biofuel storage, power to gas storage, power to liquid, hydrogen storage, hydrogen peroxide, etc.)].

As used in the claims and the specification, the term “rechargeable battery” shall preferably not exclusively refer to lithium-ion, lithium-ion polymer, nickel-metal hydride, nickel-iron, nickel-cadmium, lead-acid batteries.

As used in the claims and the specification, the term “capacitor” shall preferably not exclusively refer to supercapacitors, ultracapacitors, double-layer capacitors (e.g. with activated carbons, carbon aerogels, carbon nanotubes, nanoporous carbon, graphene, carbid-derived carbon), pseudocapacitors (e.g. with polymers, metal oxides), hybrid capacitors (e.g. with asymmetric electrodes, lithium-ion capacitors, with composite electrodes), electrolytic capacitors (e.g. aluminium electrolytic capacitors).

As used in the claims and the specification, the terms “first swappable rechargeable power source”, “second swappable rechargeable power source” shall preferably not exclusively refer to swappable power sources wherein said first swappable rechargeable power source and said second swappable rechargeable power sources are configured to be swappable/to be swapped at least for one another.

As used in the claims and the specification, the term “inductive” shall also refer to resonant inductive, strongly coupled magnetic resonant, etc. and the term “capacitive” shall also refer to resonant capacitive, etc.

As used in the claims and the specification, the term “magnetodynamic” shall preferably not exclusively refer to magneto-mechanical systems using translational and/or rotational motion of a magnetic element or arrays of magnetic elements to wirelessly transfer power. The systems can include inductive loops on one side (e.g. a primary side) and inductive loops, piezoelectric transducers, electrostatic transducers on another side (e.g. a secondary side). Magnetic elements can be included on primary/secondary sides.

As used in the claims and the specification, the term “thermal management system” shall refer to active and/or passive systems.

As used in the claims and the specification, the term “tempering systems using phase change materials” shall refer to systems using a pure phase change material (PCM) substance and to systems using methods for increasing the thermal conductivity (e.g. inserted fins, heat pipes; added fillers, foams, particles, nanostructures; metal/semimetal/nonmetal materials; carbon, graphite, graphene, composites), and to systems using dispersed/decentralised/microcapsule packaging.

As used in the claims and the specification, the term “tempering systems using heat pipes” shall also refer to systems using heat sinks, heat spreaders, vapor chambers, condensers, evaporators, etc., shall refer to compound cooling, natural convection cooling, and shall refer to systems using thermal conductance materials in any shape and form (e.g. tubes, foams, fibres, etc.) to transport, spread, dissipate, etc. heat/cold.

As used in the claims and the specification, the term “deck” shall refer to floor, ramp, plating, rail, band, rope, path, wire, cable, wharf, pier, mole, jetty, quay, and the like.

As used in the claims and the specification, the term “overhead” shall refer to beam, ceiling, roof, soffit, marquee, rail, band, rope, path, wire, cable, and the like.

As used in the claims and the specification, the term “partition” shall refer to bulwark, bulkhead, wall, frame, rib, and the like.

As used in the claims and the specification, the term “solitary construction” shall refer to column, pile, pole, mast, arm, and the like.

As used in the claims and the specification, the term “dedicated construction” shall refer to a construction with a main purpose to hold, keep, support, etc. a charging station and/or a charging interface.

As used in the claims and the specification, the term “adjustable construction” shall preferably not exclusively refer to level adjustable/plan/angle adjustable constructions.

As used in the claims and the specification, the term “mobile construction” shall preferably not exclusively refer to any type of construction providing mobility.

Adjustable constructions and mobile constructions can use any convenient navigation, micronavigation, positioning, tracking systems and methods (e.g. vision, acoustic, electromagnetic, photoelectric, radio, etc.), can use sensors/multisensors (e.g. proximity, electrical, temperature sensors, etc.), targets, cameras, controls, etc. Both systems can be powered mechanically, hydraulically, electrically, electromagnetically, pneumatically, manually, etc. Both systems can include and/or be coupled with any type of movable/extendable/folding/pivotably rotatable/sliding/rolling/suspended/floating/translational, etc. construction providing adjustability/mobility. Both systems can provide various degrees of freedom and/or dispose of various axis numbers. Both systems can use wired/wireless local/distant communication systems, networks, methods, and protocols. The adjustable/mobile constructions can be provided with drones, robots, robotic arms, actuators, etc.

As used in the claims and the specification, the term “controllable construction” shall refer to manual control, computer control, remote control, radio control, mobile control, electric control, electronic control, etc.

The charging interfaces provided at about a naval construction can be attached, detachably attached, mounted, posed, hung up, suspended, etc., and can be provided at about the naval construction in active/inactive positions, or combinations.

As used in the claims and the specification, the terms “onshore power source”, “offshore power source” shall refer to power generation systems, power transmission systems, power distribution systems and shall refer to mobile systems, and shall refer to “power grid”, “smart power grid”, “smart grid”, and the like as well.

The term “onshore power source” shall also refer to“onshore charging station” and the term “offshore power source” shall also refer to “offshore charging station”.

As used in the claims and the specification, the term “locate” and derivatives as in “locating electric vehicles” shall refer to the vehicles which can be stationary or in a motion when located at the water vessel.

As used in the claims and the specification, the term “communicate at least partially in relation with charging/discharging” shall refer to vertical communication between layers and/or horizontal communication within a same layer, or combinations, and shall refer to communication between any number of nodes/clouds from any layer wherein only communication between two members (from a same or a different layer) is possible.

As used in the claims and the specification, “A/DB” shall refer to A and/or B.

As used in the claims and the specification, the singular forms are intended to include the plural forms as well.

The term “to couple” and derivatives shall refer to a direct or indirect connection via another device and/or connection, such a connection can be mechanical, hydraulical, electrical, electronical, electromagnetical, pneumatical, communication, functional, etc.

The term “to provide” and derivatives as in “water vessel providing two or more charging stations”, “charging station providing at least one adjustable/mobile charging interface”, etc., shall preferably not exclusively refer to “to include and/or to be coupled with”, shall refer to providing a respective device, function, service, etc.

The terms “to comprise”, “to include”, “to contain”, “to provide” and derivatives specify the presence of an element, but do not preclude the presence or addition of one or more other elements or groups and combinations thereof.

The term “consisting of” characterises a Markush group which is by nature closed. Single members of the group are alternatively useable for the purpose of the invention. Therefore, a singular if used in the Markush group would indicate only one member of the group to be used.

For that reason are the countable members listed in the plural. That means together with qualifying language after the group “or combinations thereof” that only one member of the Markush group can be chosen or any combination of the listed members in any numbers. In other words, although elements in the Markush groups may be described in the plural, the singular is contemplated as well. Furthermore, the phrase “at least one” preceding the Markush groups is to be interpreted that the group does not exclude one or more additional elements preceded by the phrase.

The invention will be described in reference to the accompanying drawings.

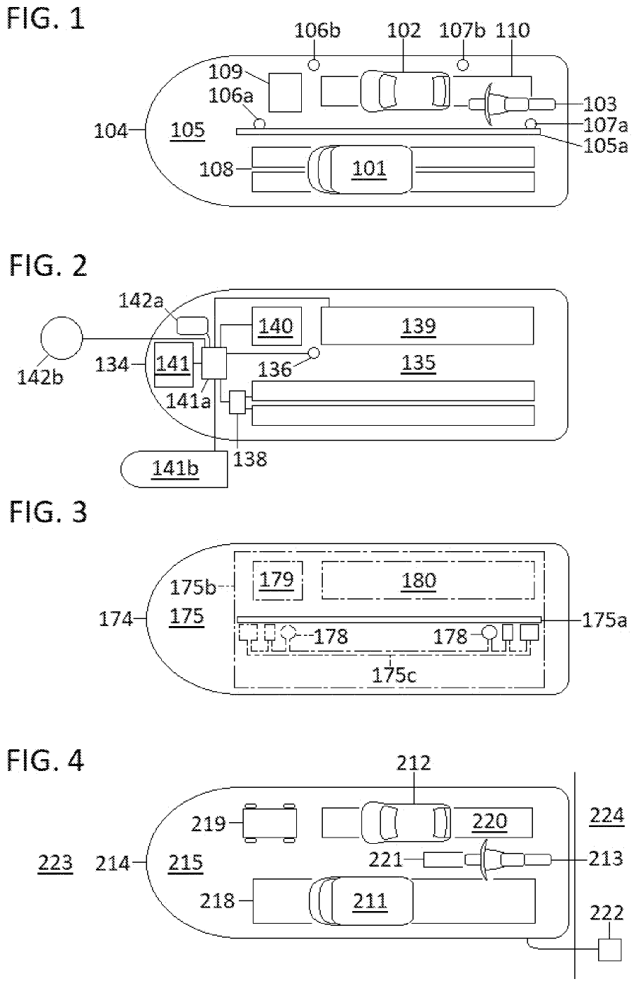

FIG. 1 is a schematic plan view of a marine charging system provided in an electric vehicle charging system comprising electric vehicles (101, 102, 103) [shown in parking/charging/discharging positions] which can be a van (101) [which can include a capacitive onboard charger providing a capacitive charging interface which can be provided at about wheels, from underneath a chassis, etc.], a car (102) [which can include an inductive onboard charger providing an inductive charging interface which can be provided from underneath a body, at about wheels, etc., and which can include an AC onboard charger providing an AC charging interface and a DC charging interface], a motorcycle (bike, scooter) (103) [which can include an inductive onboard charger providing an inductive charging interface which can be provided at about wheels, from underneath a body, etc. and which can include a DC charging interface].

The marine charging system can comprise a water vessel (104) [which can be powered by an internal combustion engine, an electric motor, sails, or combinations] including a deck (105) and a partition (105a) and comprising wired charging stations [which can be AC charging stations providing AC charging interfaces (106a, 106b) and DC charging stations providing DC charging interfaces (107a, 107b); the charging stations (106a, 107a) can be provided at about the partition (105a) [e.g. can be wall mounted] and the charging stations (106b, 107b) can be provided at about dedicated solitary constructions [which can be dedicated charging stands]. The vessel (104) can comprise wireless charging stations (108, 109, 110) [which can be a capacitive charging station providing a capacitive charging interface (108), a magnetodynamic charging station providing a magnetodynamic charging interface (109), and an inductive charging station providing an inductive charging interface (110)]. The wireless charging stations (108, 109, 110) providing wireless charging interfaces can be provided at about the deck (105).

The electric vehicles (101, 102, 103) can include rechargeable power sources/second swappable rechargeable power sources, source management systems, thermal charging management systems, onboard chargers [bidirectional chargers, smart chargers, etc. which can include communication units, controllers, protection circuits, compensation circuits, charging and communication interfaces, etc.], which systems and components can be compatible with the respective charging stations (106a, 106b, 107a, 107b, 108, 109, 110). The wired/wireless charging interfaces of the vehicles (101, 102, 103) can be provided/coupled/included in any place about their body, chassis, wheels, etc.

FIG. 2 is a schematic plan view of another embodiment of the marine charging system comprising a water vessel (134) including a deck (135) and comprising a wired charging station (136) which can be provided at about a solitary construction [which can be a column] and wireless charging stations (138, 139, 140) [which can be a capacitive charging station (138), a magnetodynamic charging station (139) and an inductive charging station (140)] including respective wireless charging interfaces [e.g. at least one pair of capacitive plates, one or more inductive loops, one or more inductive loops acting upon one or more magnetic elements] provided at about the deck (135). The wired charging station (136) and the wireless charging stations (138, 139, 140) can charge electric vehicles (not shown), second swappable rechargeable power sources (not shown) provided by the electric vehicles, first swappable rechargeable power sources (not shown) provided by the water vessel (134) to be swapped. The vessel (134) can include a swappable rechargeable power source (141) [which can include a bank of rechargeable batteries, a capacitor bank, an energy storage element] which can be coupled with a marine charging management system (141a) which can be coupled with another swappable rechargeable power source (141b) [which can be an external buoyant marine rechargeable power source which can be mechanically/electrically/data coupled with the vessel (134) and include rechargeable batteries, capacitors, energy storage elements] to provide the electric vehicles with charging/discharging power.

The vessel (134) can include a motor generator (142a) [which can be fueled with biodiesel] and can be coupled with a tidal energy to electric energy converter (142b). The generator (142a) and the converter (142b) can be coupled with the marine charging management system (141a) to provide power usable by the charging stations (136, 138, 139, 140) and/or by the swappable rechargeable power sources (141, 141b). The system can provide data transmissions in relation with charging/discharging [the electric vehicles, the swappable rechargeable power sources (141, 141b), the first/second swappable power sources]. The source management system (141a) can comprise wired/wireless communication interfaces, communication lines, wired/wireless local/distant networks and use various communication wired/wireless techniques including techniques communicating through charging interfaces [e.g. using communication lines, power lines].

FIG. 3 is a schematic plan view of another embodiment of the marine charging system comprising a water vessel (174) including a deck (175), an overhead (175b) which can be mounted on a partition (175a) and comprising a mobile wired charging stations (178) including wired charging interfaces and wireless charging stations (179, 180) including wireless charging interfaces provided at about the overhead (175b) [the wireless charging interfaces can be adjustable to provide charging/discharging].

The mobile wired charging stations (178) and respective interfaces can advantageously be charging stations of different types, levels, standards which can be suspended under the overhead (175b) and mobile along one or more guiding lanes (175c) wherein an electric vehicle can pick up a compatible charging station which can follow its motion on the deck to its parking/charging/discharging position (the process can be fully automatized). FIG. 3 shows an arrangement suitable for a roll-on/roll-of ferry boat but any other mobile arrangement is possible. Arrangements wherein only charging interfaces are mobile or coupled with a mobility device are possible. Shown mobility can be accompanied by adjustability [e.g. by providing winding charging cables, etc.].

FIG. 4 is a schematic plan view of another embodiment of the marine charging system provided in an electric vehicle charging system comprising electric vehicles (211, 212, 213) [shown in parking/charging/discharging positions] which can be a van (211) [which can include a magnetodynamic onboard charger providing a magnetodynamic charging interface], a car (212) [which can include a wireless onboard charger providing a wireless charging interface], a motorcycle (213) [which can include a wireless onboard charger providing a wireless charging interface].

The system can comprise a water vessel (214) including a deck (215) and comprising wireless charging stations (218) [which can be a magnetodynamic charging station providing a magnetodynamic charging interface provided at about the deck (215)], and (220, 221) providing wireless charging interfaces provided at about the deck (215) and a charging station providing a mobile wireless charging interface (219) [which can be a rolling charging drone including a charging pad which can be microadjustable and fully automatised or which can be a mechanical rolling board manually operated bearing the wireless charging interface and coupled with a charging cable with a stationary charging station, etc.] provided at about the deck (215). The system can be provided in a stationary offshore charging system comprising an onshore power source (222) [which can be a distribution substation, etc.] to provide the charging stations (218, 219, 220, 221) with charging/discharging power while the vessel be stationary in offshore water (223) at a port (224).

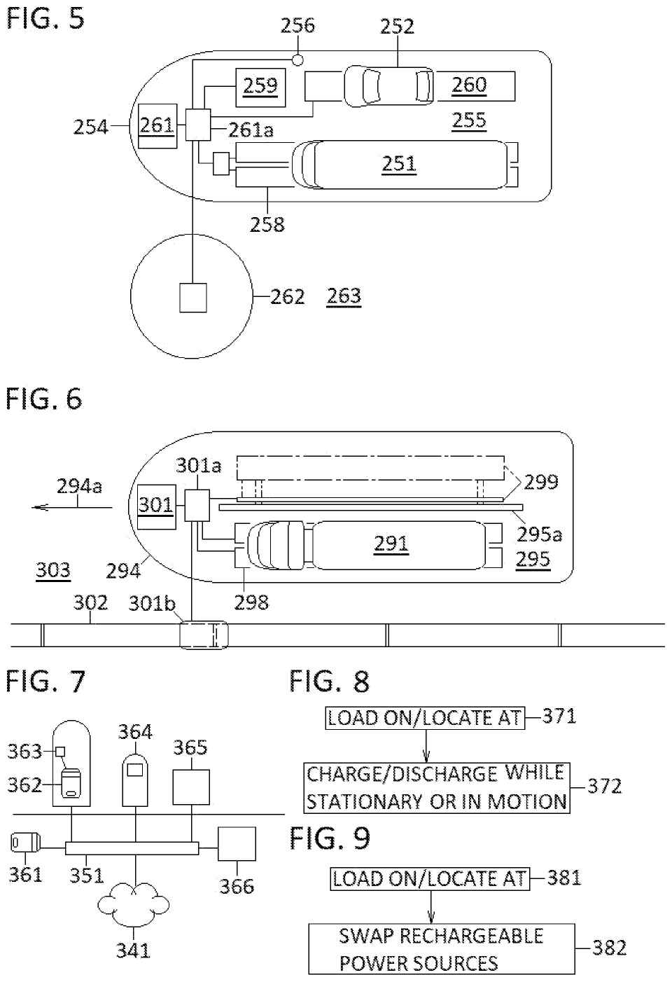

FIG. 5 is a schematic plan view of another embodiment of the marine charging system provided in an electric vehicle charging system comprising electric vehicles (251) [which can be an electric bus] and (252) [which can be a hybrid car] and a water vessel (254) including a deck (255) and comprising a wired charging station (256) which can provide a wired charging interface provided at about a solitary construction and wireless charging stations (258, 259, 260) providing wireless charging interfaces provided at about the deck (255). The vessel (254) can include a rechargeable power source (261) which can be coupled with a marine charging management system (261a) to provide the vehicles (251, 252) with charging/discharging power.

The system can be provided in a stationary offshore charging system comprising an offshore power source (262) [which can be an offshore charging station] to provide the charging stations (258, 259, 260) and/or the rechargeable power source (261) with charging/discharging power while the vessel (254) be stationary at anchor in offshore water (263). [The offshore power source (262) can provide charging/discharging power to the rechargeable power source (261) which can provide charging/discharging power to the charging stations (258, 259, 260) and/or the power source (262) can provide charging/discharging power directly to the charging stations (258, 259, 260)].

FIG. 6 is a schematic plan view of another embodiment of the marine charging system provided in an electric vehicle charging system comprising an electric vehicle (291)[which can be an electric truck] and a water vessel (294) including a deck (295) and a partition (295a) and comprising a wireless charging station (298) providing a wireless charging interface provided at about the deck (295) and a wireless charging station (299) providing an adjustable wireless charging interface [which can be provided at about the partition (295a) and can be e.g. hinged and which can have two charging positions including a vertical positon and a horizontal position or one charging position and another inactive position, etc.]. The vessel (294) can include a rechargeable power source (301) which can be coupled with a marine charging management system (301a) to provide the vehicle (291) with charging/discharging power.

The system can be provided in an offshore charging system comprising an offshore power source (302) [which can be a dynamic offshore charging system including a buoyant primary interface in offshore water (303); the interface can be provided above or under water level and the vessel can use the wireless power transfer for its power train system, auxiliary systems, etc.] to provide the charging stations (298, 299) and/or the rechargeable power source (301) with charging/discharging power [e.g. via a coupled mobile secondary interface (301b)] while the vessel (294) can be in motion (294a) [any type/direction of the vessel's motion, e.g. a forward/backward/lateral vessel motion, etc., can be considered].

FIG. 7 is a schematic of the marine charging system provided as part of a cloud/fog/edge computing system. The cloud computing system can include a cloud (341) [which can include a central server]. The fog computing system can include a fog node (351) [which can include a local port server]. The edge computing system can include edge nodes (361, 362, 363, 364, 365 and 366) which can be electric vehicles (361, 362), a charging station included by a water vessel (363), a rechargeable power source [or a first swappable rechargeable power source] included by a water vessel (364), an offshore power generator (365) [which can be a hydrogen power unit including fuel cells; offshore/onshore power generators can form a fog of power generators which can communicate with the fog node (351) at the port and/or with the cloud (341)], an onshore power source (366) [which can be a smart substation].

The onshore vehicle (361) can communicate with the fog node (351) using telephone techniques, local wireless network, etc. The onshore vehicle (362) can communicate with the charging station (363) using power line communication, a wireless personal area network, auxiliary communication lines, etc. The charging station (363) can communicate with the fog node (351) using a local wired or wireless network, etc. A fog node can be provided at the water vessel which can include a fog of charging stations (not shown). Such a vessel fog node can communicate with the fog node (351) at the port and/or with the cloud (341). The offshore power generator (365) can communicate wiredly/wirelessly. The smart substation (366) can include wired/wireless communication interfaces to communicate with the fog computing system wiredly [e.g. using Ethernet cables, fiber optics] and/or wirelessly [e.g. using WLAN, WiMAX, cellular networks]. The fog node (351) can communicate with the cloud (341) using wired communication links, wirelessly using a satellite connection, mobile communication technologies [e.g. 4G, 5G], etc.

FIG. 8 is a schematic of an embodiment of a marine charging method for an electric vehicle comprising steps of loading one or more electric vehicles on a water vessel and/or locating one or more said electric vehicles at the water vessel providing at least one combination of different charging station types (371);
at least partially charging/discharging one or more electric vehicles by at least one of the charging stations when onboard and/or when located at the water vessel while stationary and/or in motion (372).

FIG. 9 is a schematic of an embodiment of a marine swapping method for an electric vehicle comprising steps of loading one or more electric vehicles on a water vessel and/or locating one or more said electric vehicles at said water vessel, said electric vehicle providing a second swappable rechargeable power source (381);
swapping said second swappable rechargeable power source for a first swappable rechargeable power source provided by said water vessel (382).

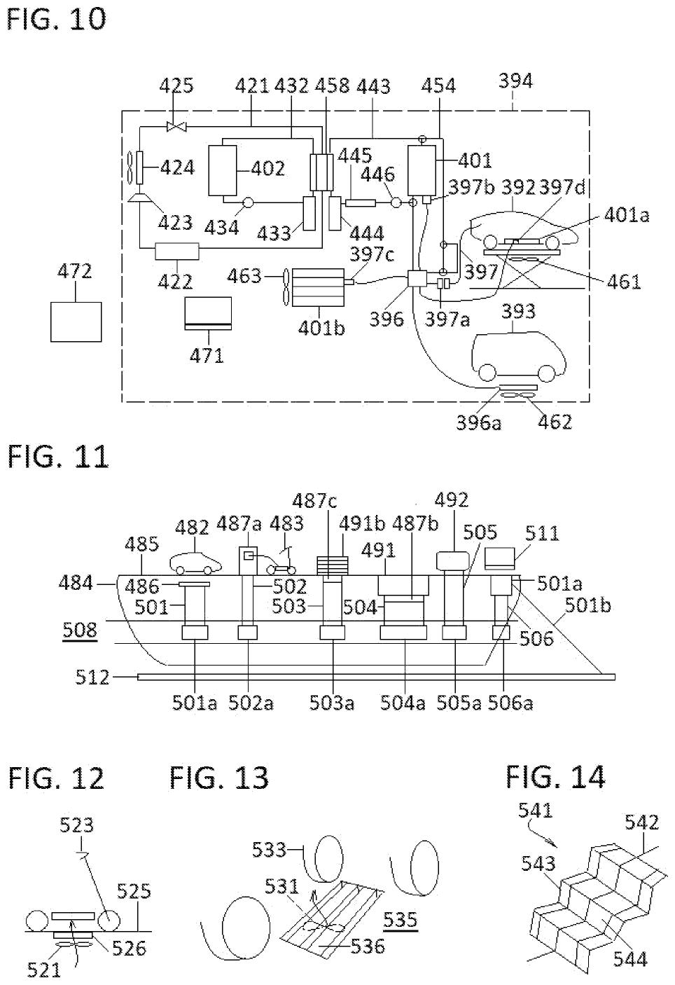

FIG. 10 is a schematic of another embodiment of the marine charging system provided in an electric vehicle charging system comprising electric vehicles (392)[which can be an electric car], (393) [which can be an electric van] and a water vessel (394) comprising a combined wired/wireless charging station (396) providing a wireless charging interface (396a) provided at about a deck [which can be an inductive charging pad], a fast DC charging interface (397a), a DC charging interface (397b) for a rechargeable power source (401) [which can include a source management system] provided by the water vessel (394), another DC charging interface (397c) for second swappable rechargeable power sources (401b) provided by the water vessel (394) and a DC charging interface (397d) for a first swappable rechargeable power source (401a) provided by the electric vehicle (392). The water vessel (394) can provide a power generator (402) [which can be a (modularly configured) hydrogen power unit/which can include a hydrogen gas tank/providing fuel cells].

The water vessel (394) can provide a thermal management system which can be a liquid tempering system which can include loops [a first loop (421) which can include a dryer/separator (422), a compressor (423), a condenser (424), a thermostatic expansion valve (425); a second loop (432) which can provide a cooling system for the hydrogen fuel cell system (402) and which can include a reservoir (433) and a pump (434); a third loop (443) which can provide a tempering system for the rechargeable power source (401) and which can include a reservoir (444), a heater (445), a pump (446); a fourth loop (454) which can provide a cooling system for the charging station (396) and a charging cable (397) of the fast DC charging interface (397a)].

The thermal management system can further be an air tempering system which can include fans (461) for cooling the first swappable rechargeable power source (401a); (462) for cooling the wireless charging interface (396a); (463) for cooling the second swappable rechargeable power sources (401b). All the loops (421, 432, 443, 454) can use the same heat exchanger (458). The system can be controlled by an onboard controller (471) which can optimalize loads, charging times, thermal management, which can perform controlling and monitoring functions and which can communicate with the vehicles (392, 393) directly [e.g. via a wireless Local Area Network] and/or the system can be controlled by a central controller (472) which can communicate with the onboard controller (471) [e.g. via a satellite connection].

FIG. 11 is a schematic side view of another embodiment of the marine charging system provided in an electric vehicle charging system comprising electric vehicles (482) [which can be an electric car], (483) [which can be an electric scooter] and a water vessel (484) comprising a wireless charging station (486) provided at about a deck (485), a DC charging station (487a), a DC charging station (487b) for a rechargeable power source (491) provided by the water vessel (484), another DC charging station (487c) for second swappable rechargeable power sources (491b) provided by the water vessel (484) which can provide a power generator (492) [which can be a motor generator] and a marine charging management system (501a) which can be statically/dynamically coupled with a charging cable (501b) with an offshore power source (512).

The water vessel (484) can provide a thermal management system which can be a liquid tempering system which can include loops [a first loop (501) which can cool the wireless charging station (486); a second loop (502) which can cool the wired charging station (487a); a third loop (503) which can cool the wired charging station (487c); a fourth loop (504) which can include a heater (not shown) and which can temper the rechargeable power source (491); a fifth loop (505) which can cool the motor generator (492) and a sixth loop (506) which can cool the marine charging management system (501a) and the charging cable (501b). All the loops (501 to 506) can be provided with a respective heat exchanger (501a to 506a) which can provide a heat exchange with an offshore water (508). The system can be controlled by an onboard controller (511) which can optimalize loads, charging times, thermal management, etc. The system can be provided in an offshore charging system comprising an offshore power source (512) [which can be a dynamic offshore charging system].

FIG. 12 is a schematic side view of a thermal management system of a wireless charging interface (526) provided on a water vessel deck (525) which can be used in the proposed marine charging system. A water vessel (not shown) can provide a thermal management system which can be an air tempering system which can include a fan (521) to cool the interface (526) when charging an electric vehicle (523).

FIG. 13 is a perspective illustration of a thermal management system of a wireless charging interface (536) provided on a water vessel deck (535) which can be used in the proposed marine charging system. A water vessel (not shown) can provide a thermal management system which can be an air tempering system which can include a fan (531) to cool the interface (536) when charging an electric vehicle (533).

FIG. 14 is a schematic of a thermal management system of a charging cable (541) which can be used in the proposed marine charging system. Charging wires (542) can be provided with a watertight protective insulation layer (543) and with a cooling layer (544) which can include coolant conducts. A surface layer (543) can be corrugated, finned, etc. to enlarge the cooling area of air cooling.

Common Features of FIGS. 1 to 14

In FIGS. 1 to 6 are shown embodiments where the vessels include charging stations and naval constructions and the electric vehicles can be charged/discharged when onboard.

The vessels can also charge/discharge by means of included/coupled charging stations charging the vehicles when located (e.g. on shore) at the vessel which can e.g. perform a function of a floating charging station for the electric vehicles when on shore and/or can be coupled with an onshore charging system, etc. The electric vehicles located at the vessel can be stationary or in a motion [e.g. the vessel can be coupled with an onshore charging station including a wired/wireless charging interface providing static/dynamic charging, the onshore charging station/charging interface can be provided at about a deck, an overhead, a partition, a solitary construction, a dedicated construction, an adjustable construction, a mobile construction, a controllable construction provided on shore and coupled with the vessel electrically, electronically, mechanically, etc.].

As shown in FIGS. 3, 4 and 6 charging stations and/or charging interfaces (both included by and/or coupled with the vessels) can be provided at about the naval constructions which can be adjustable, mobile, controllable, etc., and which can provide charging/discharging the electric vehicles on shore [e.g. a solitary construction can be a robotic arm which can extend from the vessel and pass a charging interface to an electric vehicle located at the vessel on shore, a movable, extendable, folding, pivotably rotatable, etc. deck [e.g. a ramp], partition [e.g. bulwark], etc., which can include/be coupled with a wired/wireless charging station/charging interface and can be unfolded to reach upon the shore to charge/discharge the electric vehicle, etc.]. The naval constructions can be movable, extendable, etc. over a bow, a stern, a starboard, a port side.

The same electric vehicle can be charged/discharged by means of a same system of the invention when located at the vessel on shore [e.g. when waiting at a port], while being loaded and when loaded on the vessel [e.g. while the vessel be stationary at the port and/or while in a motion, e. g. while cruising]. As shown in FIG. 3 the system of mobile wired charging stations (178) mobile along guiding lines (175c) can be extended, provided on shore. Such systems can include stationary/mobile ramps, rails, bands, ropes, cables, paths, pulley systems, lifts, carpets to allow onshore charging and/or charging while loading the vehicles and/or charging when onboard, etc. such a process can be uninterrupted.

Such coupled onboard-onshore systems can be wired/wireless. The vessel can include wired/wireless charging stations including wired/wireless charging interfaces and can be coupled through a common onshore power source [e.g. a smart grid] with onshore wired/wireless charging stations including wired/wireless charging interfaces.

A marine charging system for an electric vehicle (MCS) can provide wired/wireless data transmissions being in relation with unidirectional/bidirectional power transfer while water vessels can be stationary and/or in motion. The data transmissions can be local [e.g. via charging interfaces of the vehicles, first/second swappable power sources, local wired/wireless networks, etc.] and distant [e.g. via power cables coupling the vessel with power sources, communication cables, via satellite connections, telephone techniques, etc.]. The data transmissions can include underwater acoustic techniques. The MCS can use any convenient type of communication interfaces, lines, techniques and protocols.

The MCS can be provided in cloud/fog/edge architectures wherein communication/control systems can be at least partially in relation with charging/discharging the electric vehicles, the rechargeable power sources/swappable rechargeable power sources, the first/second swappable rechargeable power sources. The architectures can be provided e.g. within the Internet, the Internet of Things and the Industrial Internet of Things.

The cloud computing system can include a cloud (a core of the network) which can be provided at ports and/or inland and which can provide big data processing, business logic, data storage, etc., and which can provide cloud services and communicate with fog nodes, edge nodes, systems operators, billing management, clients (which can be water vessels operators, onshore vehicles operators, fleet operators, etc.), the power generators, the marine power sources, etc. The cloud can be applied for mobile networks which can include data centers, configurable networks, radio access networks and mobile clouds which can include remote, local and hybrid clouds (which can include cloudlets). The cloud can communicate with fog/edge nodes wiredly (e.g. using wired network connections) [e.g. digital lines, fiber optics, etc.] and/or wirelessly (e.g. through satellite communication, telephone techniques, etc.).

The fog computing system can include fog nodes which can include (powerful) server devices, gateways, processing, storage and communication devices which can be provided at ports, at shipping terminals, water vessels including (a fog of) the charging stations, the onshore/offshore power sources, the power generators, the rechargeable power sources/swappable rechargeable power sources provided by the vessel, onboard/onshore amenities for charging/discharging the first/second swappable rechargeable power sources, etc. The fog node can process/store data sent from edge nodes (which can be connected wiredly through local networks and/or wirelessly through radio access networks, etc.), it can process diary data, ambient conditions, etc. and it can capture other sensors data. The fog node can manage edge devices (e.g. manage charging/discharging power provided to the charging stations, the rechargeable power sources/swappable rechargeable power sources, the first/second swappable rechargeable power sources). The fog node can function as an aggregator controller which can allocate power resources, manage power flows and which can be responsible for safety.

The edge computing system can include edge nodes (which can be end-devices) which can include sensors (sensor layer), controllers, local bus, edge computing platforms, data storage, interfaces, etc. The edge nodes can be provided at the water vessels, the onshore vehicles, the rechargeable power sources, the first/second swappable rechargeable power sources, the charging stations, the onshore/offshore power sources, the power generators, etc. Edge computing platforms can communicate with the cloud/fog nodes via a core network. Edge computing platforms can perform function of local aggregators managing charging/discharging processes.

Cloud/fog/edge nodes can have local and global access. The system can enable processing, control and power management on local (edge, fog) level and information generation, servicing and control on global level (cloud). The system can enable power aggregation and interaction between power resources (e.g. power generators, onshore/offshore power sources, etc.), rechargeable power sources/swappable rechargeable power sources, the first/second swappable rechargeable power sources and the charging stations included by the water vessels. Cloud services can monitor data from fog nodes/edge nodes, human-machine interfaces (e.g. client smartphones), internet enabled devices, etc. The cloud services can make general decisions, store and process data and provide statistical analysis. The cloud/fog node/edge node system can set a real-time price for charging/discharging power based on received information from fog nodes/edge nodes (e.g. provided from different water vessels of a fleet), on power supply and demand from the rechargeable vehicles, on power supply and demand from marine power sources, power generators, etc. according to power market evaluation, energy price trend and development.

The system can make offers for a future price (e.g. during a ferry sailing) according to evaluation tests and model algorithms analysing data, implementing specific patterns to develop optimal charging/discharging/power transfer parameters (e.g. including the whole of the ferry sailing, estimating the time when the vessel can be coupled with a marine power source e.g. while stationary at a port or while in motion and coupled with an offshore wireless dynamic power transfer system, or depending on an estimated power output from a wind turbine included by the vessel and producing power usable by charging stations for charging electric vehicles when onboard during the sailing, etc.). The system can provide renewable energy management, power to grid management, booking management, pricing management, etc. The system can provide a multilevel architecture (e.g. two-level wherein edge nodes can communicate directly with clouds; a three-level architecture including edge nodes, fog nodes and clouds, or combinations). Each layer and the whole system can have various functionality patterns and architectures, can combine mobile and stationary nodes.

In coupled onboard-onshore systems of the invention a port can provide the onshore charging subsystem and the vessel can provide the onboard charging subsystem. The subsystems can be coupled electrically/electronically and provided in one or more cloud/fog/edge computing systems which can jointly manage the onboard-onshore subsystems. In such a case the vessels can include one or more charging stations and can be coupled electrically [e.g. through onshore power source/e.g. a power grid] and/or electronically [e.g. through the joint cloud/fog/edge computing system] with one or more onshore charging stations [e.g. provided at the port].

The water vessels can include and/or be coupled with power generators to produce power at least partially usable by said one or more charging stations, by the rechargeable power source/swappable rechargeable power source, by the first/second swappable rechargeable power sources.

Arrays of solar cells can be solar panels, solar modules, solar towers, solar concentrators (e.g. inclusive of fresnel lens), etc.

Hydrogen power units including fuel cells can include hydrogen production units and hydrogen storage units. Hydrogen production units can be electrolysis systems, hydrocarbons reforming systems, alcohols reforming systems, sugars reforming systems, chemical processing systems, biological processing systems, biomass processing systems, thermal processing systems, photo processing systems, metal and water systems. Hydrogen storage units can be compressed gas systems, liquified gas systems, chemical systems, electrochemical systems, physi-sorption systems, nanomaterial systems, intercalation in metals systems, intercalation in hydrides systems, inorganic gaseous systems, inorganic liquids systems, inorganic solids systems, organic gaseous systems, organic liquids systems, organic solids systems.

Wind energy to electric energy converters can be wind turbines (e.g. horizontal axis, vertical axis). Wave energy to electric energy converters can be energy harvesting devices provided in contact with waves (e.g. inclusive of linear generators, hydro turbines, air turbines, oscillating generators, oscillation columns, pressure differential converters, floating in-air converters, etc). Tidal energy to electric energy converters can be devices provided in contact with tidal changes (e.g. inclusive of hydro turbines, energy harvesting devices, etc.). Water currents energy to electric energy converters can be devices provided in contact with ambient water currents (e.g. inclusive of hydro turbines). Thermal energy to electric energy converters can be devices in contact with ambient water temperature difference, with geothermal heat sources (e.g. inclusive of hydrothermal vents energy harvesters, turbines).

Motor generators can be any type of a generator which can be an engine coupled directly or indirectly with a power generator. The engine can run on any type of fuel, preferably not exclusively on hydrogen gas, hydrogen liquid, compressed natural gases, liquefied natural gases, biofuels, low sulphur fuel oils, emulsified fuels, methanol, mixtures, hydrocarbon fuels, etc.

The water vessels comprised in the MCS can be arranged to use at least partially regenerative power wherein electric motors coupled with propellers can become generators of power which can be used by the charging stations, by the rechargeable power sources/swappable rechargeable power sources, by the first/second swappable rechargeable power sources. The vessels can comprise any device to convert water/wind motion energy into electric power apart from its propellers coupled with the motors such as hydro turbines, wind turbines of any type. These devices can be combined devices to propel the vessel and to regenerate power or can be separate dedicated devices, or combinations. Water/wind motion energy can be converted while the vessel is slowing down, while sailing under sail, etc.

The electric vehicles can include and/or be coupled with the second swappable rechargeable power source e.g. which can be contained in a body and accessible from any part of a body construction [e.g. through a hood, trunk, doors, from underneath, from above, etc.] and can be swappable by any means [which can range from a manual system over a mechanical pulley, a cord, a rail, etc. system to a fully automatic, robotic, drone, etc. system] and from any side [from underneath, from above, from the front, from behind] and/or which can be contained in a coupled vehicle, mounted on a rack (e.g. a roof rack) coupled to the vehicle from any side [e.g. from behind, from the front, from above, from underneath]. The vessels can dispose charging/discharging/stocking capacity [e.g. dedicated chargers to charge/discharge the first/second swappable rechargeable power source, manipulating and computing systems] which can be provided onboard and/or onshore.

The rechargeable power sources can be dedicated rechargeable power sources to be used for the onshore vehicles, the first/second swappable rechargeable power sources charging/discharging purposes only or can be used for proper needs of the vessels (propelling systems, auxiliary systems, etc.), or can be used for other purposes, or combinations.

The rechargeable power sources, the first/second swappable rechargeable power sources can include a package (e.g. a container, climatised container, waterproof, watertight, buoyant container), include and/or be coupled with a source management system which can include power electronics, communication interfaces, various circuit topologies including electrocomponents such as converters, inverters, voltage regulators, power factor corrections, rectifiers, filters, controllers, processors, etc. The source management systems can provide monitoring, calculating, reporting, controlling functions with regard to the source management.

The rechargeable power source, the first/second swappable rechargeable power sources can be/include an energy storage element including a complex technology (e.g. including energy storage, energy transfer, energy harvesting, energy generating, etc.) which can include power electronics, communication interfaces, various circuit topologies, etc. The rechargeable power sources, the first/second swappable rechargeable power sources can be mobile units, compact units, enclosed units, portable units, skid mounted units and the like.

The swappable rechargeable power source, the first/second swappable rechargeable power sources can comprise a functional, communication, shape compatibility, e.g. can comprise compatible power transfer interfaces, compatible communication interfaces, compatible rechargeable power sources, compatible source management systems, power cables, thermal management systems, etc. The vessel can be arranged for easy, frequent and rapid swapping of the swappable rechargeable power source, the first/second swappable rechargeable power sources [e.g. the sources can be charged/discharged, prepared, stocked, etc. for a ferryboat at a port, etc.].

The MCSs can comprise thermal management systems which can be included by the water vessels and/or located on shore/off shore and coupled with the water vessels to thermally manage charging/discharging the electric vehicles, the rechargeable power sources, the first/second swappable rechargeable power sources. The thermally managed rechargeable power sources/swappable rechargeable power sources can be used for the onshore vehicles charging/discharging purposes only or can be used for proper needs of the vessels (propelling systems, auxiliary systems, etc.), or combinations. The thermal management systems can be air tempering systems, liquid tempering systems, liquid tempering systems using offshore water as a thermal medium, tempering systems using phase change materials, tempering systems using heat pipes, or combinations. The systems can thermally manage chargers of charging stations, charging cables, charging interfaces, rechargeable batteries and/or capacitors of the power sources, etc. The thermal management systems of energy storage elements can include complex technologies. The systems can include ventilators, thermal exchangers, compressors, chillers, condensers, heaters, sensors, pumps, programmable controllers, thermal medium conducts, valves, heat pipes, vapor chambers, heat sinks, fillers, etc. The systems can use thermal exchange with offshore water.

The charging stations and/or charging interfaces provided at about a naval construction can be aligned, recessed, protruding above a surface and can be attached, detachably attached, coupled, etc.

Adjustability and mobility of charging stations/charging interfaces can provide charging/discharging the electric vehicles, the rechargeable power sources, the first/second swappable rechargeable power sources (e.g. can assist in interfacing, arranging, cleaning, servicing, upgrading, etc.).

Both systems (adjustable and mobile) can use any convenient navigation, micronavigation, positioning, tracking systems and methods (e.g. vision, acoustic, electromagnetic, photoelectric, radio, etc.), can use sensors/multisensors (e.g. proximity, electrical, temperature sensors, etc.), targets, cameras, controls, etc. Both systems can be powered mechanically, hydraulically, electrically, electromagnetically, pneumatically, manually. Both systems can be controlled manually, computer, remote, radio, mobile, electrically, electronically, etc. Both systems can be compact units wherein power electronics, communication units, etc. can be included in one unit with the charging interface or the chargers provided separately from the interfaces and can be coupled at least with power cables. Both systems (inclusive of the adjustability/mobility devices) can include or be coupled with any type of a sliding, rolling, floating, rotating, translational, suspended, etc. construction providing adjustability/mobility which can range from a winding rope to robotic arms, robots, drones, electromagnetic suspensions, etc. and which can include linear motors, rotary motors and various types of actuators. Both systems can provide various degrees of freedom and/or dispose of various axis numbers. Both systems can use wired/wireless local/distant communication systems, networks, methods, and protocols.

Common Requirements on the Marine Charging System in Cold Areas

The NICS can be provided in the Arctic, the Antarctic, subpolar and cold seas. In that case, components of the vessels and the charging elements and components can be designed to be conform with cold, extremely cold, temporarily cold conditions. Charging interfaces can be specifically designed to be protected against cold and bad weather specially when exposed onboard. The rechargeable power sources, the first/second swappable rechargeable power sources [esp. including rechargeable batteries banks] can be thermally insulated. Thermal management systems provided to manage charging/discharging can include heating systems.

No limitations are intended others than as described in the claims. The present invention is not limited to the described exemplary embodiments. It should be noted that various modifications of the MCS can be made without departing from the scope of the invention as defined by the claims.

The elements, components, integers, features, standards described in this specification and the used terminology reflect the state of knowledge at the time of the filling of this application and may be developed in the future (e.g. charging standards, charging interfaces, chargers, rechargeable power sources, energy storage elements, communication techniques, fuels, hydrogen production and hydrogen storage techniques, etc.)

### INDUSTRIAL APPLICABILITY

The present invention may advantageously provide a combined charging system for electric vehicles preferably when onboard water vessels.

The electric vehicles nay use time when located on shore at the vessel and/or when onboard for being charged and/or to swap [e.g. while waiting at a port to embark, while being loaded, during a cruise, a ferry boat transfer, etc.]

The MCS may provide bidirectional power flow. The vehicles may provide power to the water vessel and to its elements. The power may be used to power propulsion systems, auxiliary systems, to recharge (temporarily recharge) the rechargeable power sources of the vessel, the primary/secondary swappable rechargeable power sources.

The proposed swappability of the swappable rechargeable power sources may bring benefits provided by swapping rapidity, ease of servicing, etc.

The proposed cloud/fog/edge architecture may improve functionality of the system management, may enable to the electric vehicles to interact with the system (reserving charging capacity, optimalising the charging/discharging process, etc.), enable diverse modes of power trading. The MCS in a cloud-based communication system may bring efficiency, flexibility, lower costs and lower CO₂ emissions of an MCS management.

The power generators using renewable sources (arrays of solar cells, wind energy to electric energy converters, wave energy to electric energy converters, tidal energy to electric energy converters, water currents energy to electric energy converters, thermal energy to electric energy converters, motor generators) may provide power to be used for zero emission power production and supply by the NICS.

The NICS may be provided in a modular system. The proposed modularity and scalability may concern all elements of the MCS and may bring functional and financial benefits to the parties. Modular designs may use various degrees of modularity [e.g. component slottability, platform systems, holistic approach, etc]. Modules may be catalogued.

The proposed marine swapping method for electric vehicles may bring benefits provided by swapping rapidity, ease of servicing, etc.

I claim:

1. A marine charging system for an electric vehicle, comprising: a water vessel providing two or more charging stations, wherein said electric vehicle is at least partially chargeable/dischargeable by at least one of said two or more charging stations, characterised in that at least one combination of charging station types is provided preferably onboard said water vessel to charge/discharge said electric vehicle.

2. The marine charging system according to claim 1, wherein at least one said charging station type is selected from the group consisting of AC charging stations, DC charging stations, inductive charging stations, capacitive charging stations, magnetodynamic charging stations.

3. The marine charging system according to claim 1, wherein at least one said charging station is defined as a charging station providing at least one adjustable/mobile charging interface providing charging/discharging.

4. The marine charging system according to claim 1, further providing data transmissions being in relation with charging/discharging said electric vehicle and/or a rechargeable power source provided by said water vessel and/or a first swappable rechargeable power source provided by said water vessel and/or a second swappable rechargeable power source provided by said electric vehicle.

5. The marine charging system according to claim 1, wherein said marine charging system is provided as part of a computing system, wherein at least one said computing system is selected from the group consisting of cloud computing systems, fog computing systems, edge computing systems, or combinations thereof, wherein said computing system communicates at least partially in relation with charging/discharging said electric vehicle and/or a rechargeable power source provided by said water vessel and/or a first swappable rechargeable power source provided by said water vessel and/or a second swappable rechargeable power source provided by said electric vehicle.

6. The marine charging system according to claim 1, wherein said water vessel is powered by a propulsion system, wherein at least one said propulsion system is selected from internal combustion engines, electric motors, sails, or combinations thereof.

7. The marine charging system according to claim 1, wherein said water vessel provides a power generator to produce power at least partially usable by said two or more charging stations and/or by a rechargeable power source provided by said water vessel and/or by a first swappable rechargeable power source provided by said water vessel and/or by a second swappable rechargeable power source provided by said electric vehicle, wherein at least one said power generator is selected from the group consisting of arrays of solar cells, hydrogen power units providing fuel cells, wind energy to electric energy converters, wave energy to electric energy converters, tidal energy to electric energy converters, water currents energy to electric energy converters, thermal energy to electric energy converters, motor generators, or combinations thereof.

8. The marine charging system according to claim 1, wherein said water vessel is arranged to use at least partially regenerative power.

9. The marine charging system according to claim 1, wherein said water vessel provides a first swappable rechargeable power source to be swapped for a second swappable rechargeable power source provided by said electric vehicle.

10. The marine charging system according to claim 1, wherein said water vessel provides a rechargeable power source, wherein said rechargeable power source is able to provide at least said electric vehicle with charging/discharging power.

11. The marine charging system according to claim 1, wherein said water vessel provides a thermal management system to thermally manage charging/discharging said electric vehicle and/or a rechargeable power source provided by said water vessel and/or a first swappable rechargeable power source provided by said water vessel and/or a second swappable rechargeable power source provided by said electric vehicle, wherein at least one said thermal management system is selected from the group consisting of air tempering systems, liquid tempering systems, liquid tempering systems using offshore water as a thermal medium, tempering systems using phase change materials, tempering systems using heat pipes, or combinations thereof.

12. The marine charging system according to claim 1, wherein said water vessel provides a naval construction, wherein at least one said naval construction is selected from the group consisting of decks, overheads, partitions, solitary constructions, dedicated constructions, adjustable constructions, mobile constructions, controllable constructions, or combinations thereof, and wherein at least one said charging station is defined as a charging station providing at least one charging interface, wherein said charging station and/or said charging interface are provided at about said naval construction.

13. The marine charging system according to claim 1, wherein said marine charging system is provided as part of an electric vehicle charging system characterised in that it comprises: said electric vehicle coupled to least one of said two or more charging stations to be charged and/or discharged.

14. The marine charging system according to claim 1, wherein said marine charging system is provided as part of an offshore charging system comprising a marine power source, wherein at least one said marine power source is selected from the group consisting of onshore power sources, offshore power sources, or combinations thereof, wherein said marine power source is coupled to provide said two or more charging stations and/or a rechargeable power source provided by said water vessel and/or a first swappable rechargeable power source provided by said water vessel and/or a second swappable rechargeable power source provided by said electric vehicle with charging/discharging power while said water vessel be stationary and/or in motion.

15. The marine charging system according to claim 1, wherein said marine charging system is provided as part of a modular system comprising a module, wherein said module is modularly scalable and/or exchangeable.

16. A marine charging method for an electric vehicle, the method comprising steps of:
loading one or more electric vehicles on a water vessel and/or locating one or more said electric vehicles at said water vessel, said water vessel providing at least one combination of different charging station types;
at least partially charging/discharging said one or more electric vehicles by at least one of said charging stations when onboard and/or when located at said water vessel while said water vessel be stationary and/or in motion.

17. A marine swapping method for an electric vehicle, the method comprising steps of:
loading one or more electric vehicles on a water vessel and/or locating one or more said electric vehicles at said water vessel, said electric vehicle providing a second swappable rechargeable power source;
swapping said second swappable rechargeable power source for a first swappable rechargeable power source provided by said water vessel.
